(19) United States
(12) Patent Application Publication
(10) Pub. No.: US 2019/0310732 A1
(43) Pub. Date: Oct. 10, 2019

(54) TOUCH SUBSTRATES AND TOUCH DISPLAY PANELS

(71) Applicant: Kunshan Go-Visionox Opto-ELectronics Co., Ltd., Kunshan (CN)

(72) Inventors: Zhiwei Zhou, Kunshan (CN); Xiuqi Huang, Kunshan (CN); Zhenzhen Han, Kunshan (CN); Yanqin Song, Kunshan (CN); Weilong Li, Kunshan (CN); Siming Hu, Kunshan (CN)

(21) Appl. No.: 16/446,656

(22) Filed: Jun. 20, 2019

Related U.S. Application Data
(63) Continuation of application No. PCT/CN2018/110693, filed on Oct. 17, 2018.

(30) Foreign Application Priority Data
May 14, 2018 (CN) 201810453395.9

(51) Int. Cl. G06F 3/041; G06F 3/044

(52) U.S. Cl. CPC G06F 3/0412; G06F 3/0444; G06F 2203/04106; G06F 2203/04101; G06F 2203/04111

(57) ABSTRACT

A touch substrate includes a touch detection region and a sensing detection region. The touch detection region is provided with a touch electrode for identifying a touch signal. The sensing detection region is provided with a sensing electrode for identifying an environment signal. A touch display panel includes a display panel and the above-described touch substrate.

### CROSS-REFERENCES TO RELATED APPLICATIONS

This present application is a continuation application of International Application No. PCT/CN2018/110693, filed on Oct. 17, 2018, which claims the priority to Chinese Application No. 201810453395.9, entitled “TOUCH SUBSTRATE AND TOUCH DISPLAY PANEL” and filed on May 14, 2018. The entireties of these applications are incorporated by reference herein for all purposes.

### FIELD

The present application relates to display technologies, particularly relates to touch display panels and touch substrates.

### BACKGROUND

With the continuous update and iteration of display device products, a large-screen display device is more and more popular with users, and an external structure and an internal structure of the display panel are also constantly updated. Nowadays, the design of a display panel is in pursuit of a display effect of a narrow bezel, in order to bring more intense visual impact to the users. However, during actual design processes of the display panel, a certain reserved space is generally remained at the top of the display panel to place elements such as a camera, an optical sensor, a distance sensor, and the like, which will result in an oversize reserved space of the display panel, thereby affecting the narrow bezel design of the display panel.

### SUMMARY

A touch substrate includes a touch detection region and a sensing detection region. The touch detection region is provided with a touch electrode for identifying a touch signal. The sensing detection region is provided with a sensing electrode for identifying an environment signal.

A touch display panel includes a display panel and a touch substrate provided on the display panel. The touch substrate includes a touch detection region and a sensing detection region. The touch detection region is provided with a touch electrode for identifying a touch signal. The sensing detection region is provided with a sensing electrode for identifying an environment signal.

### BRIEF DESCRIPTION OF THE DRAWINGS

FIG. 1 is a schematic structural view of a touch substrate in an embodiment.

FIG. 2 is a schematic structural view of a touch substrate in another embodiment.

FIG. 3 is a schematic structural view of a touch electrode in a touch detection region in an embodiment.

FIG. 4 is a schematic structural view of a sensing electrode in a sensing detection region in an embodiment.

FIG. 5 is a schematic structural view of a sensing electrode in a sensing detection region in another embodiment.

FIG. 6 is a schematic structural view of a sensing electrode in a sensing detection region in another embodiment.

FIG. 7 is a schematic structural view of a touch display panel in an embodiment.

FIG. 8 is a schematic structural view of a touch display panel in another embodiment.

### DETAILED DESCRIPTION OF THE INVENTION

Embodiments of the present application will be described in detail below with reference to the accompanying drawings, so that the above objects, features and advantages of the present application can be more apparent and understandable. Numerous specific details are set forth in the following description in order to provide a thorough understanding of the present application. However, the present application can be implemented in many other ways different from those described herein, and a person skilled in the art can make similar modifications without departing from the application, and therefore, the present application is not limited by the specific embodiments disclosed below.

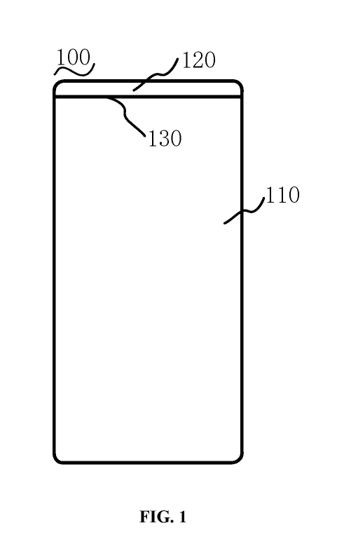

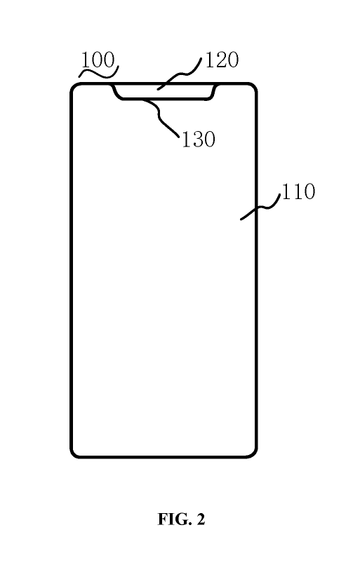

In an embodiment, as shown in FIGS. 1 and 2, a touch substrate 100 is provided. The touch substrate 100 includes a touch detection region 110 and a sensing detection region 120. The touch detection region 110 is not overlapped with the sensing detection region 120. FIGS. 1 and 2 show two arrangements of the two regions, which are used to illustrate a relationship between the two regions, but are not used to limit specific positions of the two regions.

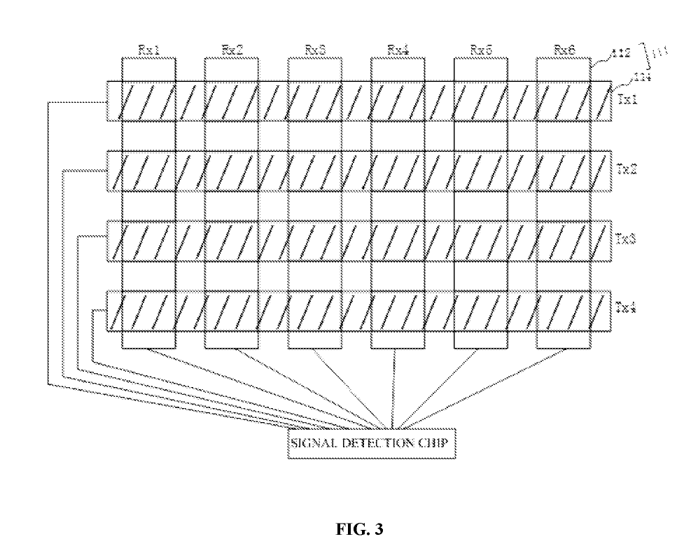

In this embodiment, as shown in FIG. 3, the touch detection region 110 is provided with a touch electrode 111. The touch electrode 111 includes a touch induction electrode 112 and a touch driving electrode 114 arranged in a crisscrossed manner. The touch induction electrode 112 and the touch driving electrode 114 may be made of Indium Tin Oxide (ITO) thin film, and positions of the touch induction electrode 112 and the touch driving electrode 114 may be exchanged. As shown by gray shadows in FIG. 3, an induction capacitor will be formed at an overlapped position of the touch induction electrode 112 and the touch driving electrode 114. Further, the touch induction electrode 112 and the touch driving electrode 114 are electrically connected to a signal detection chip through a signal line. The signal detection chip may determine a touched position on the touch substrate and calculate a specific coordinate of the touched position to identify a touch signal, by detecting a change of capacity of the induction capacitor.

In this embodiment, the sensing detection region 120 is provided with a sensing electrode. The sensing electrode is similar to the touch electrode, and is also a block electrode. The sensing electrode is electrically connected to the signal detection chip through the signal line similarly. The sensing electrode may sense a changing environment signal, such as an environment light signal or a distance signal, and change the environment signal into an electrical signal, and then transmit the electrical signal to the signal detection chip through the signal line. Further, the signal detection chip may identify a type and intensity of the environment signal by signal comparison, and instruct a display device to perform a corresponding action according to a detection result, such as instructing the display device to automatically adjust display brightness of a display panel or to automatically adjust a sound volume of a microphone, and the like.

In the above-described touch substrate, different detection regions are provided on a substrate, and the touch electrode and the sensing electrode are provided on different detection regions respectively, so that the same touch substrate may not only identify the touch signal, but also identify the environment signal, which makes full use of a space of the touch substrate, and saves a space for placing an environment sensor, so that a narrow bezel design of the display panel is easy to be realized.

In an embodiment, as shown in FIGS. 1 and 2, the sensing detection region 120 is located at one side of the touch detection region 110. A first fixed potential line 130 is provided at an adjacent position of the touch detection region 110 and the sensing detection region 120. In this embodiment, the first fixed potential line 130 is configured to shield signal transmission between the touch electrode and the sensing electrode. A shape of the first fixed potential line 130 may not be a regular straight line or a curve line as shown in FIG. 1 or FIG. 2, but the first fixed potential line 130 shall completely separate the two regions to obstruct signal interference from different electrodes in the two regions.

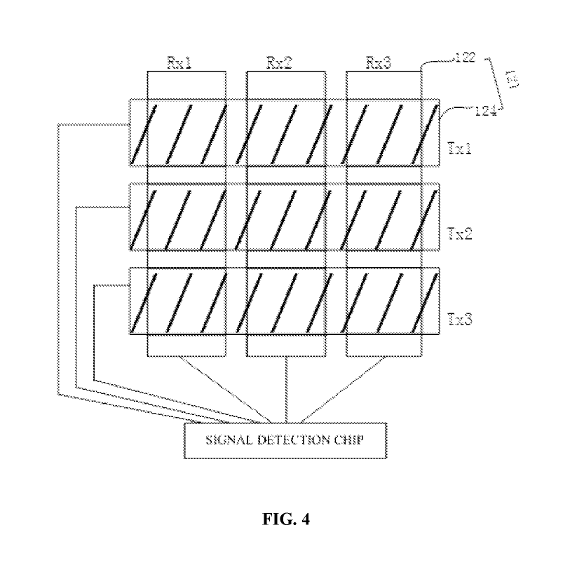

In an embodiment, as shown in FIG. 4, the sensing electrode provided in the sensing detection region 120 is a distance sensing electrode 121. An arrangement of the distance sensing electrode 121 is the same as an arrangement of the touch electrode 111. Similarly, the distance sensing electrode 121 also includes an induction electrode 122 and a driving electrode 124 arranged in a crisscrossed manner, but sizes of a single induction electrode 122 and a single driving electrode 124 of the distance sensing electrode 121 are slightly larger than sizes of a single induction electrode 112 and a single driving electrode 114 of the touch electrode 111, and only one layer of the distance sensing electrode 121 may be arranged. Further, the sizes of the single induction electrode 122 and the single driving electrode 124 of the distance sensing electrode 121 may be increased by 30% than the sizes of the single induction electrode 112 and the single driving electrode 114 of the touch electrode 111. After an electrode area of the distance sensing electrode 121 is increased, the amount of change of the capacitance signal detected by the distance sensing electrode 121 is increased, which may effectively detect a change of a distance between a human body and the display device. Specifically, when the human body approaches the sensing detection region 120, a coupling capacitor is formed by the human electric field and the distance sensing electrode 121. The distance sensing electrode 121 may sense a distance between the human body and the display device by the amount of change of the coupling capacitor, and convert the distance signal into a corresponding electrical signal, then transmit the electrical signal to the signal detection chip. The signal detection chip may identify a distance between the human body and the display device by signal comparison and instruct the display device to perform a corresponding action. In this embodiment, the distance sensing electrode 121 may affect light transmittance to some degree, thus the distance sensing electrode 121 may be provided bypass a light transmitting position of an optical element.

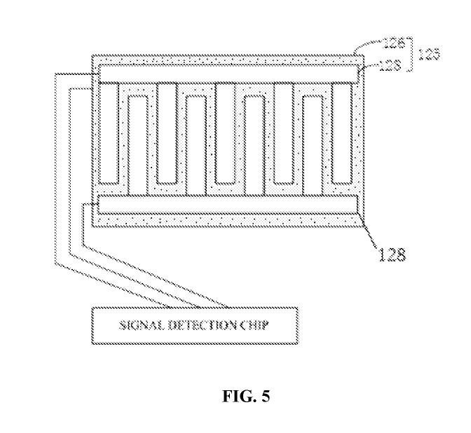

In an embodiment, as shown in FIG. 5, the sensing electrode provided in the sensing detection region 120 is an environment light sensing electrode 125. The environment light sensing electrode 125 is made of a transparent photosensitive material. The photosensitive material may specifically be aluminum doped Indium Tin Oxide (ITO) or other metal doped oxide. In addition, an arrangement of the environment light sensing electrode 125 is different from the arrangement of the touch electrode 111. As shown in FIG. 5, the environment light sensing electrode 125 generally includes a monolithic electrode 126 arranged in a lower layer and a comb-shaped electrode 128 arranged in a staggered manner in an upper layer. The monolithic electrode 126 arranged in the lower layer is doped with metal, and is configured to detect an intensity change of the environment light of the display device. The comb-shaped electrodes 128 arranged in the upper layer may not be doped with metal, and is configured to cut the monolithic electrode 126 in the lower layer into different regions, to improve detection accuracy of the environment light sensing electrode 125, and functions as a signal transmission. Further, the comb-shaped electrode 128 arranged in the upper layer may also be other shapes, as long as the comb-shaped electrode 128 can cut the monolithic electrode 126 and function as a signal transmission. The shape shown in the drawing is merely intended to be illustrative but not limiting. Specifically, when the intensity of the environment light of the display device changes, the environment light sensing electrode 125 may convert the sensed light signal into a corresponding electric signal, and then transmit the electric signal to the signal detection chip. The signal detection chip may identify the intensity change of the environment light of the display device by signal comparison and instruct the display device to perform a corresponding action. In this embodiment, one or more sets of the environment light sensing electrode 125 may be provided, and positions need to be provided bypass the light transmitting position of the optical element.

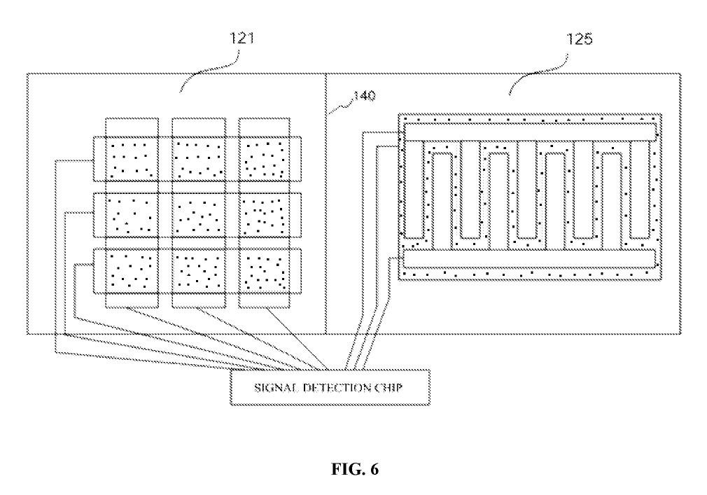

In an embodiment, as shown in FIG. 6, the sensing electrode provided in the sensing detection region 120 is the distance sensing electrode 121 and the environment light sensing electrode 125. A second fixed potential line 140 is provided between the distance sensing electrode 121 and the environment light sensing electrode 125. In this embodiment, the second fixed potential line 140 functions to shield signal transmission between the distance sensing electrode 121 and the environment light sensing electrode 125. A shape of the second fixed potential line 140 may not be a regular straight line as shown in FIG. 6, but the second fixed potential line 140 shall completely separate the two types of electrodes to obstruct signal interference between the two types of electrodes.

Further, an arrangement of the above-described distance sensing electrode 121 is the same as the arrangement of the touch electrode 111. Similarly, the distance sensing electrode 121 includes an induction electrode and an driving electrode arranged in a staggered manner, but a size of the distance sensing electrode 121 is slightly larger than a size of the touch electrode 111, and only one layer of electrodes may be arranged. When the human body approaches the sensing detection region 120, a coupling capacitor is formed by the human electric field and the distance sensing electrode 121. The distance sensing electrode 121 may sense a distance between the human body and the display device by the amount of change of the coupling capacitor, and convert the distance signal into a corresponding electrical signal, then transmit the electrical signal to the signal detection chip. The signal detection chip may identify a distance between the human body and the display device by signal comparison and instruct the display device to perform a corresponding action. The above-described environment light sensing electrode 125 is made of a transparent photosensitive material. The photosensitive material may specifically be aluminum doped Indium Tin Oxide (ITO) or other metal doped oxide. An arrangement of the environment light sensing electrode 125 is different from that of the touch electrode. The environment light sensing electrode 125 specifically includes a monolithic electrode arranged in a lower layer and a comb-shaped electrodes arranged in a crisscrossed manner in an upper layer. The monolithic electrode arranged in the lower layer is doped with metal. The comb-shaped electrodes arranged in the upper layer may not be doped with metal. When the intensity of the environment light of the display device changes, the environment light sensing electrode may convert the sensed light signal into a corresponding electric signal, and then transmit the electric signal to the signal detection chip. The signal detection chip may identify the intensity change of the environment light of the display device by signal comparison and instruct the display device to perform a corresponding action.

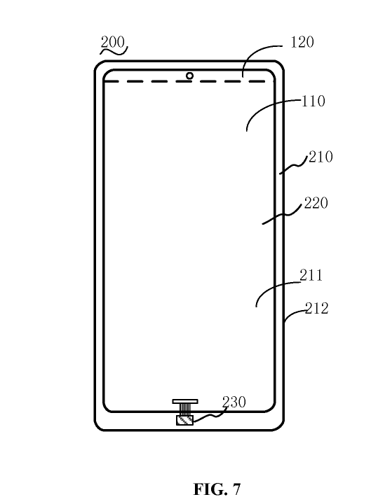

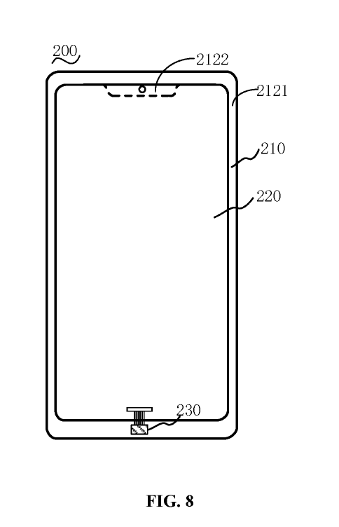

In at least one embodiment, as shown in FIGS. 7 and 8, a touch display panel 200 is provided. The touch display panel 200 includes a display panel 210, a touch substrate 220 and a signal detection chip 230 provided on the touch display panel 200 through a bonding region of the touch substrate 220. The touch substrate 220 is provided on the display panel 210. The touch substrate 220 includes a touch detection region and a sensing detection region. As shown in FIGS. 7 and 8, solid lines of inner bezels in the drawings indicate a shape of the touch substrate 220, and broken lines of inner bezels in the drawings indicate boundary lines between the touch detection region and the sensing detection region. For easy understanding, an area of the touch substrate 220 as shown in FIGS. 7 and 8 is smaller than that of the display panel 210. However, in the actual applications, a size of the touch substrate 220 may be the same as that of the display panel 210, and may also be slightly smaller than that of the display panel 210. The shape in the drawings is merely intended to be illustrative but not limiting. Specifically, a touch electrode is provided in the touch detection region. The touch electrode is electrically connected to a signal detection chip 230 through a signal line. The signal detection chip 230 determines a touched position and calculates a specific coordinate according to a change of capacity of a capacitor formed by the touch electrodes arranged in a crisscrossed manner, so as to identify a touch signal. A sensing electrode is provided in the sensing detection region. The sensing electrode is electrically connected to the signal detection chip 230 through a signal line similarly. The signal detection chip 230 determines a type and intensity of an environment signal by reading an electrical signal converted by the sensing electrode, and instructs a display device to perform a corresponding action, such as instructing the display device to automatically adjust display brightness of a display panel or to automatically adjust a sound volume of a microphone, and the like.

In at least one embodiment, as shown in FIGS. 7 and 8, the display panel 210 includes a display region 211 and a non-display region 212. In these embodiments, the touch detection region 110 of the touch substrate 220 is provided in the display region 211, and the sensing detection region 120 of the touch substrate 220 is provided in the non-display region 212. With such an arrangement, the display region 211 of the display panel 210 may has a touch function, and the space of the non-display region 212 may also be fully utilized, which reduces a reserved position for placing elements, thereby realizing a narrow bezel design of the touch display panel 200.

In an embodiment, as shown in FIG. 8, the non-display region 212 may include a bezel region 2121 provided around the display region 211 and a groove region 2122 provided at one edge of the display region 211. The sensing detection region 120 may be provided on the bezel region 2121 or the groove region 2122. Specifically, as shown in FIG. 7, when the non-display region 212 of the display panel 210 only includes a bezel region 2121, the sensing detection region 120 may be provided in the bezel region 2121. Preferably, the sensing detection region 120 may be provided in an upper bezel region 2121 and avoid an optical element on the upper bezel. As shown in FIG. 8, when the non-display region 212 of the display panel 210 not only includes a bezel region 2121 but also includes a groove region 2122, the sensing detection region 120 may be provided in the bezel region 2121 and/or in the groove region 2122. Preferably, the sensing detection region 120 may be provided in the groove region 2122 and avoid a position of the optical element in the groove region 2122. With such an arrangement, functions of distance detection and environment light detection may be integrated on the touch display panel 200, making the entire display device more intelligent.

In at least one embodiment, the sensing detection region 120 is provided on the bezel region or on the groove region of the non-display region 212, or a boundary position of the bezel region or of the groove region. The non-display region provided with the sensing detection region has a light transmittance higher than other part of the non-display region not provided with the sensing detection region or the display region, thereby the sensing electrode may detect a change of the surrounding environment more accurately. In this embodiment, the groove region is obtained by etching a TFT array and oxide films of the display panel and the groove region is not provided with a pixel unit. In addition, it is no need to cut an base substrate and an encapsulation substrate corresponding to the groove region, thus the groove region is made with lower difficulty and good light transmittance.

In an embodiment, the display panel 210 may be a glass display panel or a flexible display panel. When the display panel 210 is the glass display panel, the touch substrate 220 is attached to an encapsulation glass of the display panel 210 and constitutes a rigid touch display panel 220 together with the display panel 210. When the display panel 210 is the flexible display panel, the touch substrate 220 is attached to a flexible encapsulation layer of the display panel 210 and constitutes a flexible touch display panel 220 together with the display panel 210. In addition, the touch substrate 220 may also directly function as an encapsulation cover plate of the display panel 210, and the touch display panel 200 constituted by the touch substrate 220 may be rigid or may be flexible.

In the above-described display panel 200, the touch detection region 110 of the touch substrate 220 is provided in the display region 211, and the sensing detection region is provided in the non-display region 212, which realizes an effect of integrating the sensing detection element on the display panel 210. A slotted space or a bezel space of the display panel is reduced, so that the display panel 210 can easily realize the narrow bezel design. And the function of the touch display panel 200 is more intelligent and integrated, which is the development trend of the touch display panel 200 in the future.

Each of the technical features of the above-described embodiments may be combined arbitrarily. To simplify the description, all the possible combinations of each of the technical features in the above embodiments are not described. However, all of the combinations of these technical features should be considered as within the scope of the present specification, as long as such combinations do not contradict with each other.

The above-described embodiments merely represent several embodiments of the present application, and the description thereof is more specific and detailed, but it should not be construed as limiting the scope of the present application. It should be noted that, for a person skilled in the art, several variations and improvements may be made without departing from the concept of the present application, and these are all within the protection scope of the present application. Therefore, the protection scope of the present application shall be subject to the appended claims.

1. A touch substrate comprising:
a touch detection region provided with a touch electrode for identifying a touch signal; and
a sensing detection region adjacent to the touch detection region, the sensing detection region being provided with a sensing electrode for identifying an environment signal.

2. The touch substrate according to claim 1, wherein a first fixed potential line is provided at an adjacent position of the touch detection region and the sensing detection region, and the first fixed potential line is configured to shield signal transmission between the touch electrode and the sensing electrode.

3. The touch substrate according to claim 2, wherein the sensing electrode comprises a distance sensing electrode, and the environment signal comprises a distance signal.

4. The touch substrate according to claim 2, wherein the sensing electrode comprises an environment light sensing electrode, and the environment signal comprises an environment light signal.

5. The touch substrate according to claim 2, wherein the sensing electrode comprises a distance sensing electrode and an environment light sensing electrode, the environment signal comprises a distance signal and an environment light signal;
a second fixed potential line is provided between the distance sensing electrode and the environment light sensing electrode, and the second fixed potential line is configured to shield signal transmission between the distance sensing electrode and the environment light sensing electrode.

6. The touch substrate according to claim 3, wherein a size of the distance sensing electrode is larger than a size of the touch electrode.

7. The touch substrate according to claim 4, wherein the environment light sensing electrode is made of a transparent photosensitive material.

8. A touch display panel comprising:
a display panel; and
a touch substrate provided on the display panel, the touch substrate comprising a touch detection region and a sensing detection region; the touch detection region being provided with a touch electrode for identifying a touch signal; the sensing detection region being provided with a sensing electrode for identifying an environment signal.

9. The touch display panel according to claim 8, wherein the display panel comprises a display region and a non-display region; the touch detection region is provided in the display region, and the sensing detection region is provided in the non-display region.

10. The touch display panel according to claim 9, wherein the non-display region comprises a bezel region provided around the display region and a groove region provided at one side of the display region; and the sensing detection region is provided in the bezel region.

11. The touch display panel according to claim 9, wherein the non-display region comprises a bezel region provided around the display region and a groove region provided at one side of the display region; and the sensing detection region is provided in the groove region.

12. The touch display panel according to claim 9, wherein the non-display region comprises a bezel region provided around the display region and a groove region provided at one side of the display region; and the sensing detection region is provided in the bezel region and the groove region.

13. The touch display panel according to claim 10, wherein the bezel region provided with the sensing detection region has a light transmittance greater than that of the display region.

14. The touch display panel according to claim 11, wherein the groove region provided with the sensing detection region has a light transmittance greater than that of the display region.

15. The touch display panel according to claim 8, further comprising a signal detection chip electrically connected to the touch electrode and the sensing electrode.
